(19) United States
(12) Patent Application Publication
(10) Pub. No.: US 2026/0253893 A1
(43) Pub. Date: Aug. 27, 2026

(54) COMPOSITE PARTICLE OF LITHIUM MANGANESE IRON PHOSPHATE, AND LITHIUM-ION SECONDARY BATTERY

(71) Applicant: TOYOTA JIDOSHA KABUSHIKI KAISHA, Toyota-shi, (JP)

(72) Inventors: Daiki MAEDA, Toyota-shi, (JP); Yuki ISHIGAKI, Toyota-shi (JP)

(73) Assignee: TOYOTA JIDOSHA KABUSHIKI KAISHA, Toyota-shi (JP)

(21) Appl. No.: 19/448,354

(22) Filed: Jan. 14, 2026

(30) Foreign Application Priority Data
Feb. 21, 2025 (JP) 2025-027182

(51) Int. Cl. H01M 4/58; H01M 4/02; H01M 10/0525

(52) U.S. Cl. CPC H01M 4/5825; H01M 10/0525; H01M 2004/028

(57) ABSTRACT

A composite particle of lithium manganese iron phosphate includes a core moiety containing lithium manganese iron phosphate represented by formula (1), which is a general formula, and a shell moiety containing lithium manganese iron phosphate represented by formula (2), which is a general formula, wherein a<c. Li_{α}MnₐFe_{b}PO₄ (0.50≤α≤1.5, 0<a<1.0, 0<b<1.0, 0.9≤a+b≤1.1) Equation (1) Li_{β}Mn_{c}Fe_{d}PO₄ (0.50≤β≤1.5, 0<c<1.0, 0.9≤c+d≤1.1) (2)

### CROSS-REFERENCE TO RELATED APPLICATION

This application claims priority to Japanese Patent Application No. 2025-027182 filed on Feb. 21, 2025. The disclosure of the above-identified application, including the specification, drawings, and claims, is incorporated by reference herein in its entirety.

### BACKGROUND

### 1. Technical Field

The technology disclosed in the present specification relates to composite particles of lithium manganese iron phosphate, and the like.

### 2. Description of Related Art

Lithium manganese iron phosphate (LMFP) is used as an active material of cathodes in lithium-ion secondary batteries. Japanese Unexamined Patent Application Publication No. 2021-9838 (JP 2021-9838 A) describes the use of granules of Mn-rich LMFP and Fe-rich LMFP as cathode active material grains in order to improve energy density and cycle resistance.

### SUMMARY

The method in JP 2021-9838 A is intended to combine Mn-rich LMFP that contributes to energy density with Fe-rich LMFP that contributes to cycle resistance. However, the present inventors have found that there is still room for improvement in cycling characteristics.

The present specification provides a lithium manganese iron phosphate particle and a lithium-ion secondary battery that effectively suppress elution of Mn and improve cycling characteristics.

The technology disclosed in the present specification is embodied in the following lithium manganese iron phosphate particle and lithium-ion secondary battery.

[1] A composite particle of lithium manganese iron phosphate, the composite particle including
a core moiety containing lithium manganese iron phosphate represented by Formula (1) that is a general formula

Li_{α}MnₐFe_{b}PO₄(0.50≤α≤1.5, 0<a<1.0, 0<b<1.0, 0.9≤a+b≤1.1) Formula (1),

and
a shell moiety containing lithium manganese iron phosphate represented by Formula (2) that is a general formula

Li_{β}Mn_{c}Fe_{d}PO₄(0.50≤β≤1.5, 0<c<1.0, 0<d<1.0, 0.9≤c+d≤1.1) Formula (2),

in which
a<c holds.

[2] The composite particle according to [1], in which, in the above Formula (1), 0<a<0.80, 0.20<b<1.0 holds, and in the above Formula (2), 0.70≤c<1.0, 0<d≤0.30 holds.

[3] The composite particle according to [2], in which, in the above Formula (1), 0<a≤0.60, 0.40≤b<1.0 holds.

[4] The composite particle according to [3], in which, in the above Formula (1), 0.55≤a≤0.65, 0.35≤b≤0.45 holds, and in the above Formula (2), 0.75≤c≤0.85, 0.15≤b≤0.25 holds.

[5] A lithium-ion secondary battery including a cathode containing the composite particle according to any one of [1] to [4].

In the composite particle, a Mn proportion a of LMFP of the shell moiety of the particle surface is smaller than a Mn proportion c of LMFP of the core moiety inside the particle. Accordingly, elution of Mn is suppressed on the surface side, at the particle level. On the other hand, the Mn proportion of LMFP is great in the core moiety of the composite particle, and accordingly energy density can be improved. As a result, the amount of Mn reaching an anode can be suppressed more effectively than with particles in which LMFP with similarly differing Mn proportions are randomly compounded, thereby contributing to more excellent cycling characteristics. A lithium-ion secondary battery including such a cathode can exhibit excellent cycle characteristics.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a cell of a lithium-ion secondary battery;

FIG. 2 is a cross-sectional view schematically illustrating an exemplary composite-particle disclosed herein; and

FIG. 3 is a cross-sectional view schematically showing another example of the composite particles disclosed in the present specification.

### DETAILED DESCRIPTION OF EMBODIMENTS

The present disclosure relates to composite particles and the like for a cathode of a lithium-ion secondary battery. According to the composite particles disclosed in the present specification, it is possible to obtain excellent cycling properties by suppressing elution of Mn by using particles in which LMFP having differing elemental ratios are combined into a specific form in LMFP.

Hereinafter, the composite particles, the cathode, and the lithium-ion secondary battery will be described with reference to the drawings as appropriate. For convenience of explanation, first, an outline of a lithium-ion secondary battery and a cathode thereof will be described.

### Lithium-Ion Secondary Battery and Cathode Thereof

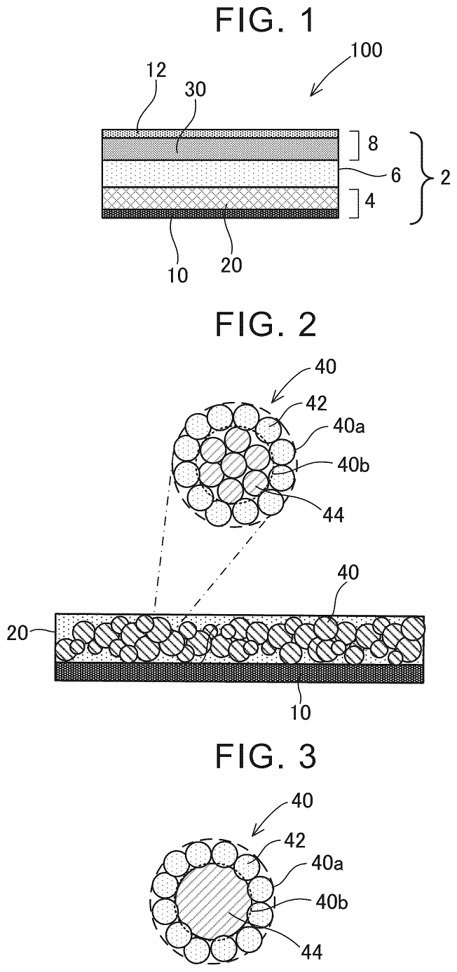

FIG. 1 schematically illustrates an example of a cell 2 of a lithium-ion secondary battery (hereinafter, simply referred to as a secondary battery) 100. As shown in FIG. 1, a cell 2 as a unit structure of the secondary battery 100 includes a cathode 4, a separator 6, and an anode 8. The cell 2 further includes a cathode current collector 10 and an anode current collector 12. The secondary battery 100 generally has a structure in which a plurality of cells 2 are stacked. The separator 6 may hold, for example, a liquid or gel electrolyte. The separator 6 is made of a known material such as a polyolefin-based microporous membrane having fine pores formed therein. The separator 6 is impregnated with a liquid electrolyte including a lithium salt such as lithium hexafluoride phosphate using organic solvents such as ethylene carbonate (EC), dimethyl carbonate (DMC), and diethyl carbonate (DEC) as a medium. Alternatively, a solid electrolyte layer may be used. The anode 8 includes an anode composite material layer 30.

FIG. 2 schematically illustrates an example of a cross section of the cathode 4. The cathode 4 includes a cathode composite material layer (hereinafter, also simply referred to as a composite material layer) 20. In some cases, the cathode 4 includes the current collector 10 integrated with the composite material layer 20. The current collector 10 is not particularly limited, but may be, for example, a metal or an alloy foil containing aluminum, nickel, or the like.

### Composite Particle

As shown in FIG. 2, the composite material layer 20 contains composite particles 40 as cathode active material particles. The composite-particle 40 comprises a shell moiety 40a and a core moiety 40b. Both the shell moiety 40a and the core moiety 40b contain LMFP as the cathode active material.

LMFP included in the shell moiety 40a is represented by the formula (1), and

LMFP included in the core moiety 40b is represented by the formula (2), and a<c.

Li_{α}MnₐFe_{b}PO₄

(0.50≤α≤1.5, 0<a<1.0, 0<b<1.0, 0.90≤a+b≤1.1) Expression (1)

Li_{β}Mn_{c}Fe_{d}PO₄

(0.50≤β≤1.5, 0<c<1.0, 0<d<1.0, 0.90≤c+d≤1.1) Expression (2)

As is apparent from the above-mentioned general formula, Mn ratio a, which is the ratio of Mn in the formula (1), is smaller than Mn ratio c, which is the ratio of Mn in the formula (2).

When the “Mn ratio a<Mn ratio c”, the quantity of Mn eluted from the cathode 4 including the composite-particle 40 can be effectively reduced. Without limiting the scope of the disclosure herein, it is believed that the lower Mn ratio of the relatively superficial LMFP in the composite-particle 40 can inhibit Mn elution than would otherwise be the case. In addition, Mn of diffusing into the electrolyte toward the anode can be suppressed. As a result, it is considered that deterioration in cycle characteristics is suppressed.

Mn ratio a and Mn ratio c can be appropriately set within 0<a<1.0 and 0<b<1.0 so that a<c, respectively.

### Mn Proportion a

Mn ratio a is, for example, 0<a<0.80. In particular, Mn ratio a is 0.40 or more, 0.45 or more, 0.50 or more, 0.55 or more, or 0.60 or more in view of the energy-density. Further, from the viewpoint of suppressing elution of Mn, from the viewpoint of electronic conductivity and ionic conductivity, 0.75 or less, 0.70 or less, 0.65 or less, 0.60 or less, 0.55 or less. Mn ratio a can be appropriately selected and set from the lower limit and the upper limit. From the viewpoint of Mn dissolution inhibition, energy density, electronic conductivity, and the like, for example, it may be 0.40 or more and less than 0.80, or 0.40 or more and 0.75 or less, or 0.40 or more and 0.70 or less, or 0.50 or more and 0.70 or less, or 0.55 or more and 0.65 or less, or 0.40 or more and 0.60 or less, or 0.50 or more and 0.60 or less.

When Mn ratio a is within the above range, Fe ratio b is, for example, 0.20<b<1.0. For example, the lower limit of b is 0.25 or more, 0.30 or more, 0.35 or more, 0.40 or more, and 0.45 or more. The upper limit of b is 0.60 or less, 0.55 or less, 0.50 or less, 0.45 or less, 0.40 or less. Therefore, b is also, for example, 0.20 to 0.60 or less, 0.25 to 0.60 or less, 0.30 to 0.60, 0.30 to 0.50, 0.35 to 0.45, 0.40 to 0.60, 0.40 to 0.50.

### Mn Proportion c

Mn ratio c is, for example, 0.70≤c<1.0 from the viewpoint of energy-density. For example, c is 0.75 or more, 0.80 or more, or 0.85 or more. Further, from the viewpoint of suppressing elution of Mn and from the viewpoint of electronic conductivity, for example, 0.90 or less, 0.85 or less, 0.80 or less, 0.75 or less. Mn ratio c can be appropriately selected and set from the lower limit and the upper limit, and can be, for example, 0.70 to 0.90, 0.70 to 0.85, 0.75 to 0.85, 0.80 to 0.90, 0.80 to 0.85, and the like.

When Mn ratio c is within the above range, Fe ratio d is, for example, 0<b≤0.30. For example, the lower limit of d is 0.10 or more, 0.15 or more, 0.20 or more, or 0.25 or more. The range of d can be appropriately selected and set from these lower limit and upper limit, but can be 0.10 or more and 0.30 or less, 0.15 or more and 0.30 or less, 0.15 or more and 0.25 or less, 0.10 or more and 0.20 or less, 0.15 or more and 0.20 or less.

Further, other variables and the like in Expression (1) and Expression (2) may be as follows.

It is 0.50 or more and 1.5 or less with respect to α and β. If this is exceeded,

LMFP is too pure, making it difficult to secure the energy-density. It may be preferable that α and β be, for example, 0.90 or more and 1.1 or less. LMFP is sufficiently pure and energy-density is ensured. Regarding a+b and c+d, both are 0.90 or more and 1.1 or less. In this range, the purity of LMFP is ensured, and the energy-density is ensured.

LMFP disclosed herein is a compound represented by Li_{α}MnₐFe_{b}PO₄, and Li_{β}Mn_{c}Fe_{d}O₄. As the doping element, when an element other than the above is added in LMFP in an amount of 0.1% by mass or more and 10% by mass or less, it is also intended to be included in LMFP.

LMFP can be identified by atomic absorption spectrometry for lithium, and ICP emission spectrometry for manganese, iron, and phosphorus. For the formulae α, β, and a to d, two significant digits are adopted. Further, when the raw material charge ratio at the time of LMFP production is known, it is also possible to determine the compositional from the charge ratio.

The shape of the shell moiety 40a and the core moiety 40b in the composite-particle 40 is not particularly limited. For example, the core moiety 40b may be coated so as to cover at least a part of the surface of the spherical core moiety 40b. In view of the reactivity as a lithium-ion secondary battery, it may be preferable that both of the shell moiety 40a and the core moiety 40b of the composite particles 40 are composed of a plurality of particles.

For example, as shown in FIG. 2, the shell moiety 40a and the core moiety 40b may be composed of the first particles 42 and the second particles 44, respectively. The composite particle 40 illustrated in FIG. 2 has a configuration in which a plurality of second particles 44 are assembled to form a core moiety 40b, and a plurality of first particles 42 are coated on the core moiety 40b. In addition, the composite particles 40 shown in FIG. 3 have a configuration in which the first particles 42 having a relatively small diameter are coated on the second particles 44 having a relatively large diameter constituting the core moiety 40b.

When the composite particle 40 has the form shown in FIGS. 2 and 3, the composite particle 40 is a so-called secondary particle or granulate. The first particles 42 and the second particles 44 are composed of LMFP represented by the formulae (1) and (2).

Each of the first particles 42 and the second particles 44 may further include a carbonaceous film for improving electron conductivity. The carbonaceous coating can include, for example, a carbonaceous material such as graphite, semi-graphite, and the like. The film thickness and the carbon content of the carbonaceous film are not particularly limited, and can be appropriately set within a known range.

In the above explanation, the first particles 42 and the second particles 44 that differ in Mn ratio of LMFP are used as core-shell composite particles. Further, as the third particle, a core-shell type complex particle can be formed using LMFP composite particles having a small or large Mn ratio.

The average particle diameter of the first particles 42 and the average particle diameter of the second particles 44 are not particularly limited. The average particle diameter of the composite particles 40 is also not particularly limited, but is, for example, 3 μm or more, 4 μm or more, 5 μm or more, 8 μm or more, and 10 μm or more, and is, for example, 20 μm or less, 18 μm or less, 15 μm or less, or the like. The mean particle size of the composite particles 40 can be obtained as D₅₀ in a volume-based particle size distribution using a laser diffraction/scattering particle size distribution meter.

### Production of Composite Particles

The composite particles 40 can be produced according to a known production method of the core-shell composite particles for the cathode active material particles. For example, the second particles 44 constituting the core moiety 40b may be provided to prepare the core moiety 40b, and the first particles 42 may be deposited or generated to coat the core moiety 40b with the first particles 42.

The first particles 42 and the second particles 44 are commercially available or can be obtained by a known process for producing olivine-type compound particles such as LMFP. The following describes, by way of example, a method in which a slurry is prepared, granulated, and calcined to obtain a first particle and/or a second particle to obtain a composite particle.

### (a) Preparation of Slurry

As a raw material of the elements constituting LMFP, a lithium compound, a manganese compound, an iron compound, and a phosphoric acid compound are mixed with solvents to prepare a slurry. The material may be any material capable of producing the final intended LMFP, such as by calcination, and such raw materials are well known to those skilled in the art with respect to LMFP. In the present specification, in order to obtain LMFP grains having an intended Mn ratio, the respective materials are blended in a predetermined elemental ratio to prepare a slurry.

As each raw material, typically, a hydroxide of a metal element, an oxide of a metal element, a nitrate of a metal element, an acetate, a sulfate, an oxalate, a carbonate, a phosphate, or the like is used. As the phosphoric acid source, lithium dihydrogen phosphate or the like can be used.

When a carbonaceous coating is attached to the particle surface, a carbon source is added to the raw material. The carbon source may include, for example, a sugar, an organic acid, and the like. Such carbon sources are known to those skilled in the art and may include, but are not limited to, for example, glucose, sucrose, fructose, citric acid, and the like. The amount of carbon source added may be, for example, from 1% to 20% by weight, based on the raw material composite material

The solvent may include, for example, water and the like. The solid concentration of the slurry may be, for example, about 20% or more and 40% or less in terms of mass fraction. Wet milling may be performed to adjust the particle size in the slurry. For example, wet grinding may be performed such that the D₅₀ is between 0.10 and 1 μm.

### (b) Drying or Granulation

The slurry is then dried. The drying may include granulating the secondary particles (precursors). As the drying method, for example, a spray drying method can be used. Following spray drying, the secondary particles may be granulated. The size of the dried particles or the secondary particles can be appropriately adjusted according to the spray drying conditions. Spray drying is advantageous in that the particle shape (spherical shape) and the particle diameter are easily controlled. The open pore particles may be obtained by setting conditions during spray drying.

By using the spray pyrolysis method instead of the spray drying, it is possible to perform the drying or granulation and the firing described later simultaneously. The spray pyrolysis method also has the advantage of easily controlling the particle shape (spherical shape) and the particle diameter.

### (c) Firing

The dried particles obtained in (b) are calcined, whereby LMFP particles can be obtained. Any heat treatment furnace (e.g., electric furnace, muffle furnace, etc.) may be used. The heat treatment atmosphere may be, for example, a nitrogen atmosphere. The heat treatment temperature can be appropriately set, for example, but may be 400° C. or higher and 700° C. or lower. The heat treatment time may be, for example, 4 hours or more and 6 hours or less. As described above, the firing may be performed using a spray pyrolysis method.

The first particles 42 and the second particles 44 thus obtained may be formed into a single particle shape, or may be formed into secondary particles having a spherical shape or the like by aggregation of primary particles.

### (d) Composite

For example, for the core moiety 40b obtained in the above steps or in any of the methods, a slurry based on the shell moiety 40a's LMFP composition is deposited on the core moiety 40b. Thereafter, the first particles 42 may be formed on the core moiety 40b by spray-drying and calcination, so that the composite particles 40 may be obtained.

Further, for example, the surface of the core moiety 40b obtained by each of the above-described steps or any of the methods may be mixed and treated so as to coat the shell moiety 40a obtained by any of the above-described methods or each of the above-described steps with the configurable first particles 42, so that the composite particles 40 may be obtained in some cases.

The composite material layers 20 contain LMFP at, for example, 70% by mass or more, 80% by mass or more, 85% by mass or more, 95% by mass or more, 98% by mass or more, and 100% by mass with respect to the total mass of the cathode active material particles. When the composite material layer 20 contains other active material particles, for example, other known olivine-type compound particles can be used. For example, other olivine-type compounds include lithium ferric phosphate (LiFePO₄, LFP), lithium manganese phosphate (LiMnPO₄, LMP), and the like. It may also include known layered rock salt-type oxides such as NCM.

The content (total amount) of the composite particles 40 in the composite layer 20 is not particularly limited, but is, for example, 80% by mass or more, 90% by mass or more, 95% by mass or more, 96% by mass or more, or 97% by mass or more of the total mass of the composite layer 20.

### Conductive Aid

The composite material layer 20 may contain a conductive auxiliary agent. The conductive auxiliary agent is an auxiliary agent for improving the electronic conductivity of the composite material layer 20. The conductive auxiliary agent is not particularly limited, and various known conductive auxiliary agents can be used. Examples of the conductive auxiliary agent include graphite such as natural graphite and artificial graphite; carbon black such as acetylene black, Ketjen black, channel black, furnace black, lamp black, and summer black; conductive fibers such as carbon fibers and metal fibers; carbon materials such as graphene and carbon nanotubes; carbon fluoride; metal powders such as aluminum and nickel powder; conductive whiskers such as zinc oxide and potassium titanate; conductive metal oxides such as titanium oxide; conductive materials such as polyphenylene derivatives. As the carbon nanotube, for example, a single-wall carbon nanotube (SW-CNT) or a multi-wall carbon nanotube (MW-CNT) including a double-wall carbon nanotube may be preferable. One kind or two or more kinds of these may be used as the conductive auxiliary agent.

The content (total amount) of the conductive auxiliary agent in the composite material layer 20 is not particularly limited, but is, for example, 0.01% by mass or more and 10% by mass or less of the total mass of the composite material layer 20.

### Binder

The composite material layer 20 may contain a binder. The binder is not particularly limited, and a known binder used for the cathode can be used as appropriate. Examples thereof include polyvinylidene fluoride and styrene-butadiene rubber. One type or two or more types of these may be used. The content of the binder in the composite material layer 20 is not particularly limited, but is, for example, 0.3% by mass or more and 15% by mass or less.

The thickness of the composite material layer 20 is not particularly limited, but has, for example, a thickness of about 10 μm or more and 500 μm or less.

According to the present specification, there is also provided a secondary battery 100 including such a cathode 4 and a stacked cell 2 including the separator 6, the anode composite material layer 30, and the anode current collector 12.

Next, a method of manufacturing the cathode 4 using the composite particles 40 will be described.

In this manufacturing method, a composite material for a composite material layer containing composite particles 40 corresponding to the composite material layer 20 is applied to the current collector 10 by a known method such as a doctor blade, dried as necessary, a precursor layer of the composite material layer 20 is prepared, dried, and pressed. In this way, the cathode 4 in a state in which the composite material layer 20 is integrated with the current collector 10 can be obtained.

According to this manufacturing process, by including the composite-particles 40 in the composite material layers 20, it is possible to easily suppress Mn elution rate and obtain the secondary batteries 100 having excellent cycling properties and the like. The secondary battery 100 using the cathode 4 can be manufactured with reference to a known method as appropriate.

While specific examples of the technology disclosed in the present specification have been described in detail above, these examples are merely illustrative and do not limit the scope of the claims. Various modifications and variations of the specific examples described above are included in the technology described in the claims. The technical elements described in this specification or in the drawings may be used alone or in various combinations, and are not limited to the combinations described in the claims at the time of filing. The technology illustrated in the present specification or the drawings can achieve a plurality of objects at the same time, and has technical usefulness in achieving one of the objects.

What is claimed is:

1. A composite particle of lithium manganese iron phosphate, the composite particle comprising:
a core moiety containing lithium manganese iron phosphate represented by Formula (1) that is a general formula
Li_{α}MnₐFe_{b}PO₄ (0.50≤α≤1.5, 0<a<1.0, 0<b<1.0, 0.9≤a+b≤1.1) Formula (1);
and
a shell moiety containing lithium manganese iron phosphate represented by Formula (2) that is a general formula
Li_{β}Mn_{c}Fe_{d}PO₄ (0.50≤β≤1.5, 0<c<1.0, 0<d<1.0, 0.9≤c+d≤1.1) Formula (2),
wherein
a<c holds.

2. The composite particle according to claim 1, wherein, in the above Formula (1), 0<a<0.80, 0.20<b<1.0 holds, and in the above Formula (2), 0.70≤c<1.0, 0<d≤0.30 holds.

3. The composite particle according to claim 2, wherein, in the above Formula (1), 0<a≤0.60, 0.40≤b<1.0 holds.

4. The composite particle according to claim 3, wherein, in the above Formula (1), 0.55≤a≤0.65, 0.35≤b≤0.45 holds, and in the above Formula (2), 0.75≤c≤0.85, 0.15≤b≤0.25 holds.

5. A lithium-ion secondary battery comprising a cathode containing the composite particle according to claim 1.
